(19) United States
(12) Patent Application Publication
(10) Pub. No.: US 2004/0099480 A1
(43) Pub. Date: May 27, 2004

(54) Vehicular accessory device

(76) Inventor: Thomas Ragan Vester, Boerne, TX (US)

Correspondence Address: SOULES & WALLACE , P.C., ATTN: JANICE LEVERETT, FROST BANK TOWER, 100 W. HOUSTON STREET, SUITE 1500, SAN ANTONIO, TX, 78205, US

(21) Appl. No.: 10/301,106

(22) Filed: Nov. 21, 2002

(51) Int. Cl. F16C 3/14

(52) U.S. Cl. 184/1.5

(57) ABSTRACT

A vehicular accessory device comprising a liquid vessel having a cap with an aperture incorporated therein. A tube is inserted through the first aperture and into an interior portion of the vessel. The vessel also includes a second aperture on its surface allowing for a valve stem to be connected to the second aperture. An air pump, or alternatively an air compressor, is attached to the valve stem; and as air is pumped into the bottle, liquid stored within the vessel moves up the tube and into an intended destination, namely into the engine, namely a transmission, or rear end of a vehicle.

### TECHNICAL FIELD

The present invention relates to a vehicular accessory device, namely an oil change accessory, designed to apply oil or other vehicular fluid into an engine, namely a transmission, or a rear end of a vehicle.

### BACKGROUND OF THE INVENTION

Various oil changing and/or supplying systems are known in the art, particularly in the automotive industry. A standard vehicle requires oil as a lubricant; however, the oil must be changed out and replenished periodically due to degradation of the lubricating capabilities and build up of unwanted acids and debris in the oil. Traditionally, a standard oil change procedure includes elevating the car; removing the drain plug and draining the old oil into a container; reattaching the drain plug; adding new oil; and properly disposing of the old oil. Many contemporary vehicles include manual transmissions that have the oil fill hole located on the side of the transmission. During the process of adding new oil to a vehicle's engine, namely a transmission, or a rear end, the location of the fill hole increased the chances of a user spilling oil. Further, replacing oil into the transmission is a difficult task for the user because the clearance area to access the fill hole is extremely tight increasing the chances for the user to become frustrated and/or physically injured in some form or fashion.

Several devices have been designed to solve the problems of traditional oil changing procedures. An example of another oil change system is seen in U.S. Pat. No. 5,070,831 (hereinafter “the '831 patent”) and U.S. Pat. No. 5,246,086 (hereinafter “the '086 patent) issued to Yunick in 1991. The '831 patent describes an internal combustion engine oil change system including an oil filter equipped with a check valve fill fitting. Specifically, new oil is supplied to the engine through the check valve fitting, thus both filling the filter with oil and back flushing the engine's oil pump. In contrast to the '831 patent, the present invention adds a valve stem directly to the accessory device. Further, the present invention has an air insertion component providing for pressurization of the housing and displacement of the fluid contained therein.

The '086 patent describes an engine lubrication system comprising of a pump and an oil conduit means defining a first pressure side for delivering oil from an outlet of the pump to parts of the engine and a second lower pressure side for returning oil from the engine parts to the pump. The conduit means include an oil filter unit having an inlet communicating with the pump outlet for discharging oil into a passage communicating with engine parts. A fill fitting in fluid communication with the first pressure side for use during an oil change process in order to supply new oil to the oil filter unit. Unlike the '086 patent, the present invention does not deliver oil directly from the pump to the engine. Instead, the present invention delivers air into a housing having oil therein. As the air pressurizes the housing, the oil is forced up the delivery tube and enters the transmission or rear end of the vehicle.

In 1995, U.S. Pat. No. 5,476,154 (hereinafter “the '154 patent”) described a powered oil change apparatus having an oil storage tank and a gasoline powered air compressor. An oil hose communicates with the storage tank and connects into a motor being serviced. The oil hose has a cooperating connector at one end which connects to a modified drain plug. However, unlike the present invention, the '154 patent relates to an apparatus that evacuates lubricating oil in situ from a crankcase and oil filter of an engine, storing and transporting the removed oil, and discharging the removed oil at an oil collection facility.

Another type of apparatus concerned with the process of changing oil is shown in U.S. Pat. No. 5,979,516 (hereinafter “the '516 patent”) describing a funnel designed to direct the flow of materials out of a container. The funnel has an inlet with a device for detachably securing the funnel to the container. However, the '516 patent fails to provide an air insertion mechanism aiding the stored fluid to be directed from the housing and into the engine of the vehicle.

In view of the abovementioned deficiencies associated with the use of current oil changing and/or supply devices, the present invention has been developed to alleviate these drawbacks and provide further benefits to the user as a whole. These enhancements and benefits are described in greater detail herein below with respect to several alternative embodiments of the present invention.

### SUMMARY OF THE INVENTION

The present invention in its several disclosed embodiments alleviates the drawbacks described above with respect to vehicular accessory devices, namely an oil change accessory designed to add new oil to a fluid containing device of a vehicle, such as a transmission or rear end.

The present invention includes a housing having an interior portion designed to store a liquid, primarily oil, therein. The housing is designed to be lightweight in nature allowing the user to easily transport this container from one location to another. The exterior portion of the housing has a handle to help a user carry the unit and an aperture designed to receive a connector. A breather tube of an air insertion mechanism is mated to the connector allowing for air to flow through the connector and into the interior portion of the housing. In one embodiment the air insertion mechanism is an air pump; and in an alternative embodiment the mechanism is an air compressor. A benefit of the air insertion mechanism is to supply air into the housing thereby force feeding the liquid into a delivery tube. This type of displacement process eliminates the user having to come in direct contact with the liquid stored inside the housing. Further, the liquid is directed toward its destination without involving the user in the actual delivery procedure. As a result, since the user is no longer required to physically access the fill hole of the transmission or rear end located within a tight clearance area by hand, the user is no longer caused frustration and/or physical injury.

A cap is fastened to the housing about its neck portion and has an aperture allowing a tube to be inserted therein. Therefore, a first end of the tube accesses the liquid stored within the housing; while a second end of the tube extends from an exterior side of the cap and communicates with the intended destination. It is therefore a goal of the present invention to prevent excess spillage of oil as it is inserted into the transmission or rear end of the vehicle.

In operation, the air insertion mechanism channels air through the breather tube and into the housing via the connector. When the air enters the housing, the internal pressure of the housing builds allowing the incoming air to displace the liquid stored within the housing. As a result, the liquid enters and upwardly moves through the tube and into its intended destination, namely the transmission or rear end of the vehicle.

The present invention may be utilized for commercial or residential uses, is easy to manufacture and even aids users who opt to change the oil of the transmission or rear end themselves. Further, the compact nature of the present invention eliminates the need for bulky oil changing equipment commonly used by personnel managing large scale operations.

Further advantages of the invention will be more clearly understood from the following description of illustrative embodiments thereof, to be read by way of example and not of limitation in conjunction with the apparatus shown in the accompanying drawings.

### BRIEF DESCRIPTION OF THE DRAWINGS

The invention will now be described in greater detail in the following way of example only and with reference to the attached drawings, in which:

FIG. 1 is a front view of a vehicular accessory device having a tube communicating with an interior portion of the device.

FIG. 2 is a front view of the vehicular accessory device having a handle attached to an exterior portion of the device.

FIG. 3 is a surface front view of the vehicular accessory device showing an air pump being attached to the device through a valve stem connection.

FIG. 4 is an alternative surface front view of the vehicular accessory device showing an air compressor connected to the device through the valve stem.

### MODE(S) FOR CARRYING OUT THE INVENTION:

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

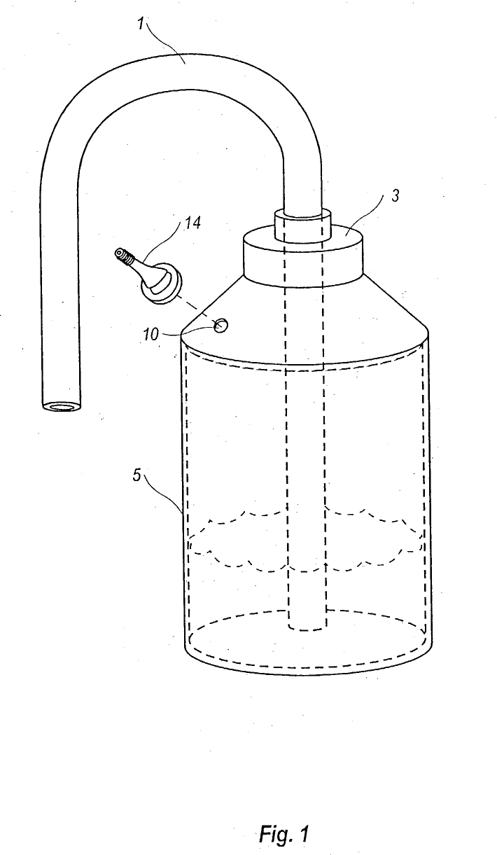

FIG. 1 depicts a vehicular accessory device, preferably having a cylindrical shape and being unitary in structure, designed to be used by a fluid containing device, such as an engine, namely the transmission, or a rear end of a vehicle. The vehicular accessory device incorporates a housing 5, made of plastic, steel or any other durable material, capable of storing liquid, namely oil, within its interior portion. Preferably, the housing 5 is made of a non-chemically reactive plastic.

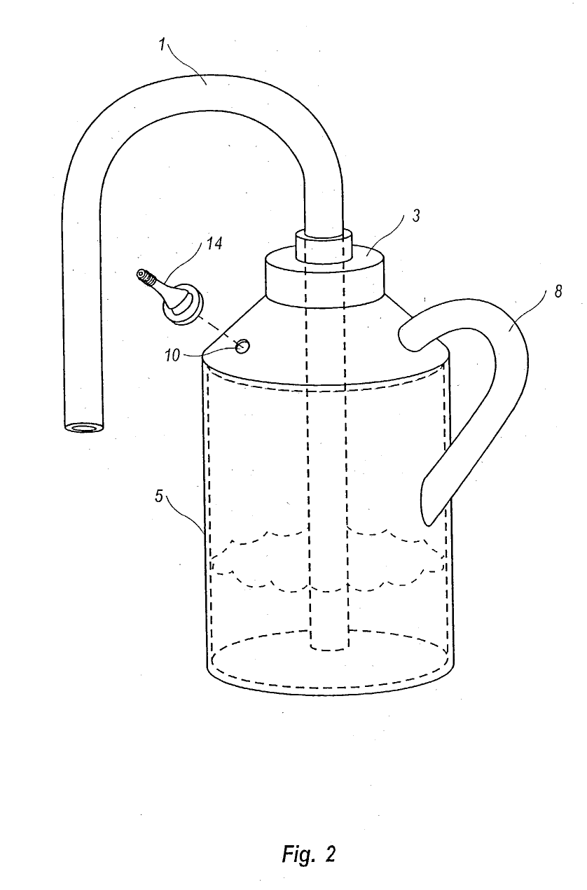

As shown in FIG. 2, a handle 8 may be attached to the exterior surface of the housing 5 to provide for easy transportability for the user. The exterior surface has an aperture 10 adapted to receive a connector 14. The connector 14 may be a valve stem or other connective device configured to accept an air insertion mechanism therein. In an alternative embodiment, at least one connector may be fastened to multiple apertures 11 bored through the exterior surface of the housing 5 in order to increase the acceptance of air flow stemming from the air insertion mechanism.

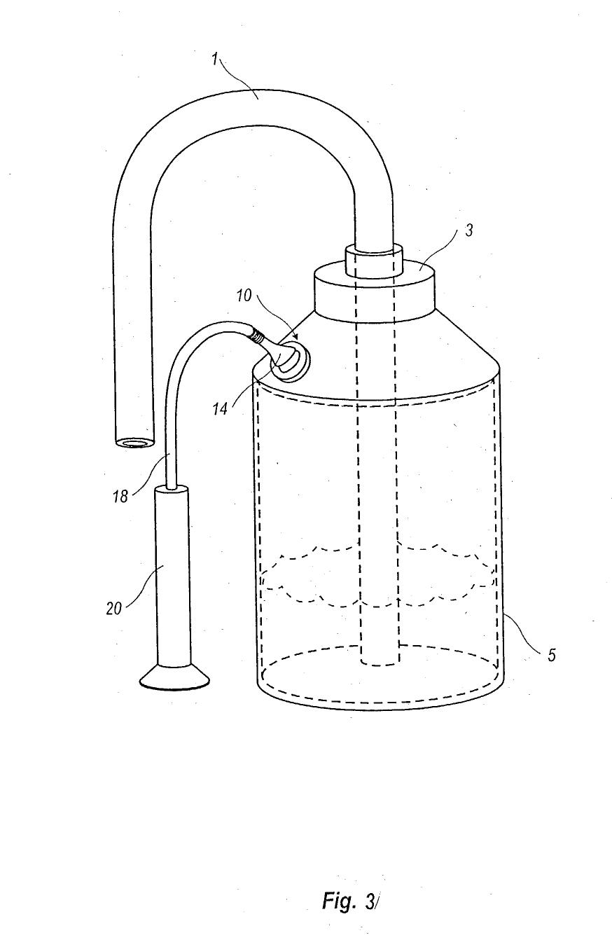

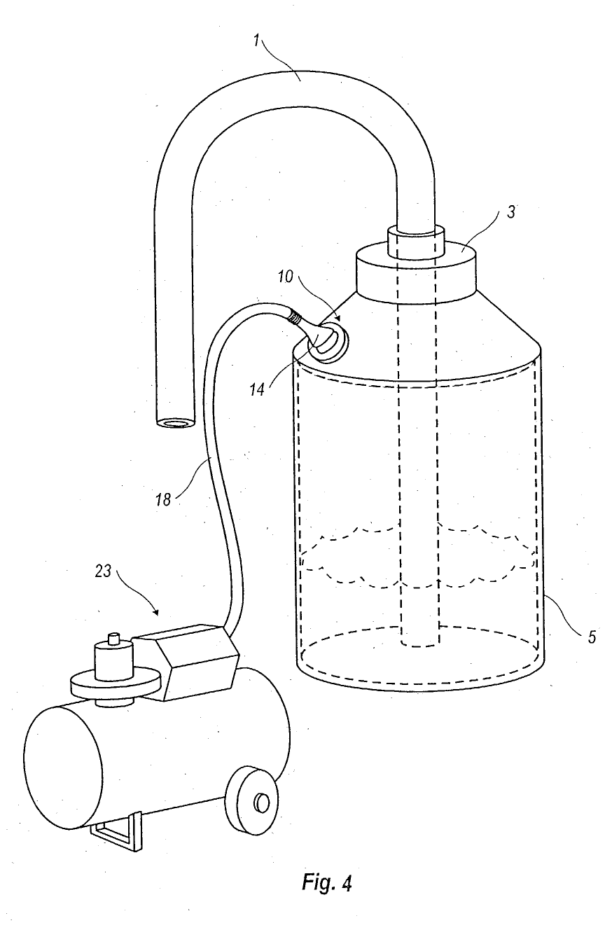

The air insertion mechanism has a breather tube 18 adapted to attach to the connector 14 allowing for air to move through the connector 14 and into the interior portion of the housing 5. In a preferred embodiment, the air insertion mechanism is capable of delivering up to ten pounds of air pressure and may either be an air pump 20 as shown in FIG. 3 or an air compressor 23 as depicted in FIG. 4. In FIG. 3, the air pump 20 may be configured to include positive displacement technology such as piston, diaphragm, rotary vane or a screw style pump. Alternatively, the pump 20 may incorporate negative displacement technology such as centrifugal, axial and regenerative blowers.

In FIG. 4, the air compressor 23 preferably provides air at a pressure above atmospheric pressure. The air compressor 23 may have many pump drive types such as direct current, alternate current, and gas or diesel engines; and in a most preferred embodiment, the compressor 23 may be adapted to generate a vacuum. Further, the compressor 23 may include at least one integrated air tank for compressed air storage or be capable of discharging air directly to an output valve.

A cap 3 is designed to be removably attached to the housing 5, desirably about a neck portion of the housing 5. Here, the cap 3 may either have a peripheral thread within its interior sides in order to communicate with a corresponding threaded neck portion; or alternatively, a peripheral portion of the cap 3 may be configured to be flush to exterior sides of the neck portion. The cap 3 may be either fixedly attached to or removably fastened to the housing 5.

In any embodiment, the cap 3 has an aperture 10, preferably positioned in a central location, bored into and through the cap 3 allowing a tube 1 to be inserted through the aperture 10 and access the interior portion of the housing 5. Specifically, a first end of the tube 1, being disposed within the housing, is in direct communication with the stored liquid; and a second end of the tube 1 is orthogonally positioned and outwardly protrudes from an exterior side of the cap 3. The second end of the tube 1 is ultimately designed to contact the fluid containing device, such as the transmission or rear end of the vehicle or other intended destination. In a preferred embodiment, the cap 3 has an incorporated tube guide 25 extending perpendicularly from the exterior surface of the cap 3 itself. The tube 1 is capable of being inserted into the tube guide 25 and through the cap 3.

Operatively speaking, the air insertion mechanism channels air through the breather tube 18 and into the housing 5 via the connector 14. When the air enters the housing 5, the internal pressure of the housing 5 builds allowing the incoming air to displace the liquid stored within the housing 5. As a result, the liquid enters and upwardly moves through the tube 1 and into its intended destination, namely the fluid containing device, such as the transmission or rear end of the vehicle.

Whereas the invention has been shown and described in connection with the preferred embodiments thereof, it will be understood that many modifications, substitutions, and additions may be made which are within the intended broad scope of the following claims. From the foregoing, it can be seen that the present invention accomplishes at least all of the stated objectives.

### INDUSTRIAL APPLICABILITY:

The present invention finds specific industrial applicability in the automotive and vehicular accessories industry.

What is claimed and desired to be secured by Letters Patent is as follows:

1. A vehicular accessory device designed to communicate with a fluid containing device of a vehicle comprising:
a housing capable of storing liquid within its interior portion;
a cap removably attached to said housing and having an aperture bored through said cap;
a tube inserted through said aperture of said cap; and
a connector mounted onto an aperture positioned through an exterior surface of said housing and adapted to receive an air insertion mechanism.

2. The vehicular accessory device as recited in claim 1, wherein said tube is disposed within an interior portion of said housing.

2. The vehicular accessory device as recited in claim 1, wherein said connector is a valve stem.

3. The vehicular accessory device as recited in claim 1, wherein said housing further comprises a handle attached on said exterior surface of said housing.

4. The vehicular accessory device as recited in claim 1, wherein said air insertion mechanism is an air pump.

5. The vehicular accessory device as recited in claim 1, wherein said air insertion mechanism is a compressed air tank.

6. The vehicular accessory device as recited in claim 1, further comprising an airflow conduit extending from said air insertion mechanism and is operatively mated to said connector.

7. The vehicular accessory device as recited in claim 1, further comprising at least one connector capable of being fastened to multiple apertures bored through said housing.

8. The vehicular accessory device as recited in claim 5, wherein said air pump includes positive displacement technology is selected from the group consisting of a piston, diaphragm, rotary vane and a screw-style pump.

9. The vehicular accessory device as recited in claim 5, wherein said air pump includes negative displacement technology is selected from the group consisting of a centrifugal blower, an axial blower and a regenerative blower.

10. The vehicular accessory device as recited in claim 6, wherein said compressor having a pump drive incorporated therein, said pump drive is selected from a group consisting of a direct current engine, an alternate current engine, a gas engine and a diesel engine.

11. The vehicular accessory device as recited in claim 1, wherein said cap has a tube guide orthogonally extending from an exterior surface of said cap and designed to accept said tube therein.

12. The vehicular accessory device as recited in claim 1, wherein said air insertion mechanism is capable of delivering up to ten pounds of air pressure to said housing.

13. The vehicular accessory device as recited in claim 3, wherein said valve stem is a tire valve stem.
